(19) United States
(12) Patent Application Publication
(10) Pub. No.: US 2023/0319329 A1
(43) Pub. Date: Oct. 5, 2023

(54) SYSTEMS AND METHODS FOR CREATING MEDIA MANIFESTS THAT INCLUDE NON-MEDIA FILES

(71) Applicant: META PLATFORMS TECHNOLOGIES, LLC, Menlo Park, CA (US)

(72) Inventor: Colleen Kelly Henry, Oakland, CA (US)

(21) Appl. No.: 17/586,732

(22) Filed: Jan. 27, 2022

(51) Int. Cl. H04N 21/236; H04N 21/262; H04N 21/6547

(52) U.S. Cl. CPC H04N 21/23614; H04N 21/26258; H04N 21/6547

(57) ABSTRACT

A computer-implemented method for creating media manifests that include non-media files may include (i) creating, for a media item, a media manifest that lists files that are relevant to the media item and available for download by a client device by (a) adding at least one media file to the media manifest that, when played by a media player on the client device, plays the media item and (b) adding at least one non-media file to the media manifest that cannot be played by the media player to play the media item but facilitates playing the media item and (ii) providing, by a server, to the client device, the media manifest that comprises the at least one media file and the at least one non-media file. Various other methods, systems, and computer-readable media are also disclosed.

### BRIEF DESCRIPTION OF THE DRAWINGS

The accompanying drawings illustrate a number of exemplary embodiments and are a part of the specification. Together with the following description, these drawings demonstrate and explain various principles of the instant disclosure.

FIG. 1 is a block diagram of an exemplary system for creating media manifests that include non-media files.

FIG. 2 is a flow diagram of an exemplary method for creating media manifests that include non-media files.

FIG. 3 is an illustration of an exemplary manifest that includes non-media files.

FIG. 4 is an illustration of an exemplary interaction between a server hosting a manifest that includes non-media files and a client device.

FIG. 5 is an illustration of an additional exemplary interaction between a server hosting a manifest that includes non-media files and a client device.

FIG. 6 is an illustration of an exemplary interaction between a server hosting a manifest that includes non-media files and multiple client devices.

Throughout the drawings, identical reference characters and descriptions indicate similar, but not necessarily identical, elements. While the exemplary embodiments described herein are susceptible to various modifications and alternative forms, specific embodiments have been shown by way of example in the drawings and will be described in detail herein. However, the exemplary embodiments described herein are not intended to be limited to the particular forms disclosed. Rather, the instant disclosure covers all modifications, equivalents, and alternatives falling within the scope of the appended claims.

Features from any of the embodiments described herein may be used in combination with one another in accordance with the general principles described herein. These and other embodiments, features, and advantages will be more fully understood upon reading the following detailed description in conjunction with the accompanying drawings and claims.

### DETAILED DESCRIPTION OF EXEMPLARY EMBODIMENTS

When downloading a media item such as a video from a server, a client may be presented with a media manifest that lists the relevant files for playing the media item on the client device. A media manifest may include files of different types, qualities, and/or resolutions, enabling the client to select the files that best fit the client's needs (e.g., optimal resolution for a display on the client, of a type that can be decoded by a codec installed on the client, etc.). A media manifest may be created in accordance with a manifest standard that specifies the types of files that may be included in the media manifest and the format of the list of those files. Currently, media manifests created in accordance with existing standards may include only files intended to be played by a media player to play the media item, such as audio files, video files, and/or subtitles. In some cases, media manifests may also include metadata about media files. The present disclosure is generally directed to systems and methods for creating a media manifest in accordance with a manifest standard that includes non-media files that enhance the ability of a client device to play the media item.

The systems described herein may include various types of files in a media manifest, camera information (e.g., lens, position, orientation, etc.), geographical coordinates, adaptive bitrate playback rate control logic, full player software libraries, software encoders, software decoders, game data, game state, avatars, projection data such as equirectangular or cubemap, machine learning model training data, and/or post-processing filters, in order to enable the client device to play the most up-to-date, highest-quality version of the media possible as efficiently as possible. In some embodiments, the systems described herein may include decode complexity metrics in a manifest in order to enable the client to select the highest-complexity encoding that the client system is capable of decoding.

In some embodiments, the systems described herein may improve the functioning of a computing device by improving the ability of the computing device to play media. Additionally, the systems described herein may improve the fields of streaming media and/or media manifests by creating media manifests that include files that enhance the ability of client devices to play streaming and/or downloaded media.

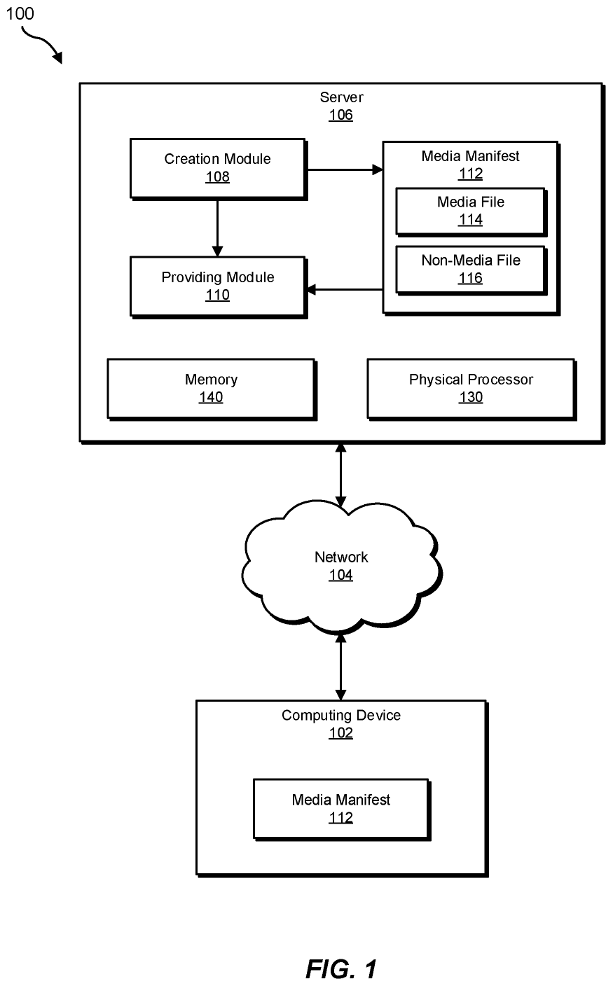

In some embodiments, the systems described herein may create a manifest that lists both media and non-media files and make the manifest and files available to a client. FIG. 1 is a block diagram of an exemplary system 100 for creating media manifests that include non-media files. In one embodiment, and as will be described in greater detail below, a server 106 may be configured with a creation module 108 that may create, for a media item, a media manifest 112 that lists files that are relevant to the media item and available for download by a client device (e.g., a computing device 102) by adding at least one media file 114 to media manifest 112 and adding at least one non-media file 116 to media manifest. In addition, server 106 may be configured with a providing module that provides, to the client device, media manifest 112 (e.g., via a network 104).

Media manifest 112 generally represents any listing of files relevant to a media item that are available for download by a client. In some embodiments, a media manifest may be created in accordance with a manifest standard that specifies the types of files that may be included in the media manifest and/or the format of the media manifest. In some embodiments, the systems described herein may create multiple manifests representing the same or partially same sets of files in order to deliver different things to different clients based on need. For example, the systems described herein may create two separate manifests for the same media item in order to enable A/B testing of new technologies and/or to restrict the availability of certain files to authorized clients.

Media file 114 generally represents any digital file that, when played by a media player on the client device, plays a media item (e.g., audio and/or video). For example, a media file may be an audio file, a video file, and/or an add-on to an audio or video file such as an enhancement layer for a video file, a subtitle file, and/or any other relevant file designed to be played by a media player.

Non-media file 116 generally represents any digital file that cannot be played by a media player to plays a media item. In some examples, a non-media file may enhance the playback of a media item by a media player in some way. For example, a non-media file may be a media player, installer for a media player, link to download a media player, plug-in for a media player, update for a media player, machine learning model training data for a machine-learning-based media player, post-processing filters for a media item, and/or three-dimensional projection data for a three-dimensional media player. In some examples, a non-media file may enable playback of a media item by an application that is not a media player. For example, model positioning data may enable a game engine or other rendering engine to play back a record of model positions over time (e.g., a recording of events in a game) as a video.

Server 106 generally represents any type or form of backend computing device that may host media manifests and/or files listed in media manifests. Examples of server 106 may include, without limitation, media servers, application servers, database servers, and/or any other relevant type of server. Although illustrated as a single entity in FIG. 1, server 106 may include and/or represent a group of multiple servers that operate in conjunction with one another. In some embodiments, media manifests and/or media files may be served by peer-to-peer systems in addition to or as an alternative to a server.

Computing device 102 generally represents any type or form of computing device capable of reading computer-executable instructions. For example, computing device 102 may represent a device capable of playing audio or video, such as a television, dedicated video player (e.g., embedded in a car or other device), dedicated audio player, and/or personal computing device. Additional examples of computing device 102 may include, without limitation, a laptop, a desktop, a wearable device, a smart device, an artificial reality device, a personal digital assistant (PDA), etc.

As illustrated in FIG. 1, example system 100 may also include one or more memory devices, such as memory 140. Memory 140 generally represents any type or form of volatile or non-volatile storage device or medium capable of storing data and/or computer-readable instructions. In one example, memory 140 may store, load, and/or maintain one or more of the modules illustrated in FIG. 1. Examples of memory 140 include, without limitation, Random Access Memory (RAM), Read Only Memory (ROM), flash memory, Hard Disk Drives (HDDs), Solid-State Drives (SSDs), optical disk drives, caches, variations or combinations of one or more of the same, and/or any other suitable storage memory.

As illustrated in FIG. 1, example system 100 may also include one or more physical processors, such as physical processor 130. Physical processor 130 generally represents any type or form of hardware-implemented processing unit capable of interpreting and/or executing computer-readable instructions. In one example, physical processor 130 may access and/or modify one or more of the modules stored in memory 140. Additionally or alternatively, physical processor 130 may execute one or more of the modules. Examples of physical processor 130 include, without limitation, microprocessors, microcontrollers, Central Processing Units (CPUs), Field-Programmable Gate Arrays (FPGAs) that implement softcore processors, Application-Specific Integrated Circuits (ASICs), portions of one or more of the same, variations or combinations of one or more of the same, and/or any other suitable physical processor.

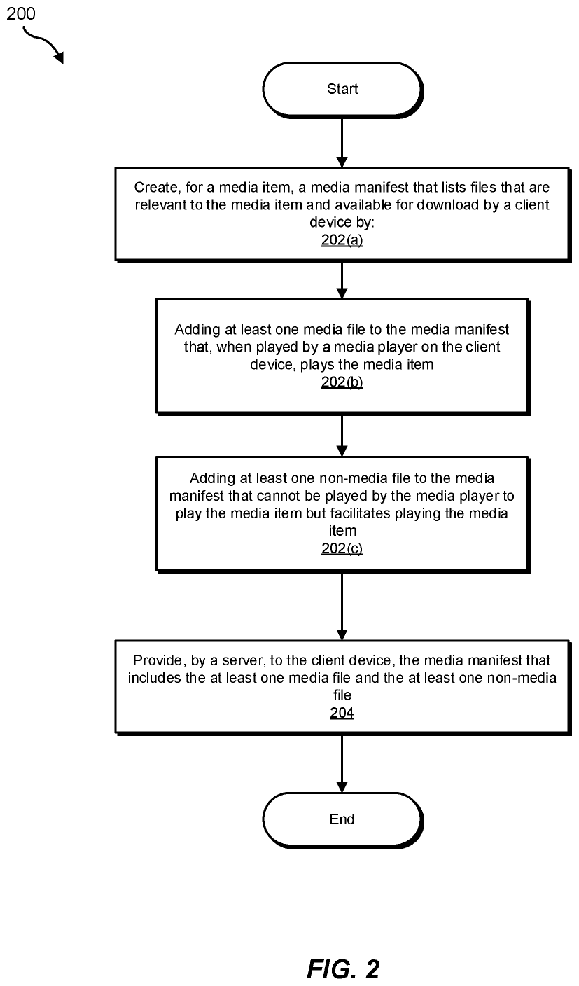

FIG. 2 is a flow diagram of an exemplary method 200 for creating media manifests that include both media files and non-media files. In some examples, at step 202(a), the systems described herein may create, for a media item, a media manifest that lists files that are relevant to the media item and available for download by a client device by, at step 202(b), adding at least one media file to the media manifest that, when played by a media player on the client device, plays the media item and, at step 202(c), adding at least one non-media file to the media manifest that cannot be played by the media player to play the media item but facilitates playing the media item.

The systems described herein may create a media manifest in a variety of ways and/or contexts. For example, the systems described herein may be installed on a media server that serves audio and/or video to client devices. In one example, the systems described herein may be part of a media service for a social networking platform and may serve media on the social networking platform. In some examples, the systems described herein may identify audio and/or video media items that are available for download and/or streaming by client devices and may create media manifests for the available media items.

In one example, the systems described herein may identify a video and may create a media manifest for the video that includes video files encoded via different codecs at different resolutions as well as a decode complexity metric for each of the encoded video files, a link the download the latest version of a media player that plays at least one of the encoded video files, and/or a plug-in to a media player that enhances video playback though technologies such as downloadable software decoders, metadata based enhancement plugins, artificial-intelligence-based super resolution filters, and/or general post processing filters such as debanding or dynamic range compression. By including a decode complexity metric for each of the encoded video files, the systems described herein may enable a client to select the file that best fits the client. For example, a client with considerable processing power such as a laptop with a graphical processing unit may select a high-quality video file encoded with a high-complexity codec while a client with less processing power such as a smartphone may select a lower-quality video file encoded with a lower-complexity codec. In another example, if a client (e.g., a smartphone) is plugged in and power consumption is not a concern, the client may download a compressed video stream which is more heavily compressed at the expense of decode complexity, whereas if the client is running on battery power, the client may select a different stream that is lighter on the resource utilization for power consumption.

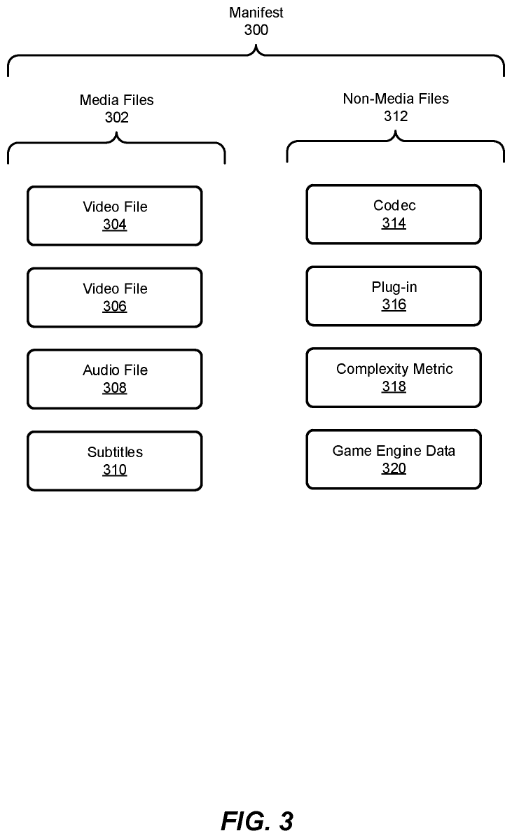

In some examples, the systems described herein may create media manifests that include various types of media files and non-media files. For example, as illustrated in FIG. 3, the systems described herein may create a manifest 300 that includes media files 302, such as a video file 304, a video file 306 (e.g., at a different resolution and/or in a different video format), an audio file 308 (e.g., a soundtrack for the video), and/or a subtitles 310, as well as non-media files 312, such as codec 314 (e.g., to decode video file 304), plug-in 316, complexity metric 318 (e.g., for video file 304), and/or game engine data 320.

Returning to FIG. 2, at step 204, the systems described herein may provide, by a server, to the client device, the media manifest that includes at least one media file and at least one non-media file.

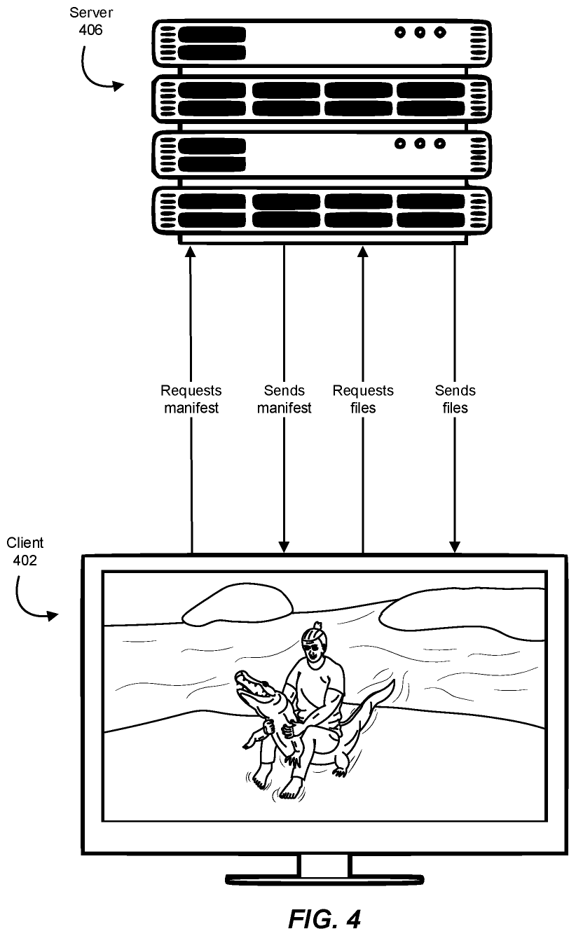

The systems described herein may provide the media manifest in a variety of ways and/or contexts. For example, as illustrated in FIG. 4, a client 402 may request a manifest from a server 406. In one example, a client may request a manifest for a documentary on competitive alligator wrestling. In one example, server 406 may send the manifest for the documentary to client 402 in response to the request. Client 402 may select appropriate files from the manifest and request those files from server 406. For example, client 402 may select an encoded video file at an appropriate resolution for a display surface of client 402 that is encoded by a codec with which client 402 is configured, a plug-in for a media player on client 402 that will enhance the playback of the documentary and which was not previously installed on client 402, and/or an audio file that is alternative audio for the documentary including a “making of” feature and additional interviews with the alligator wrestlers.

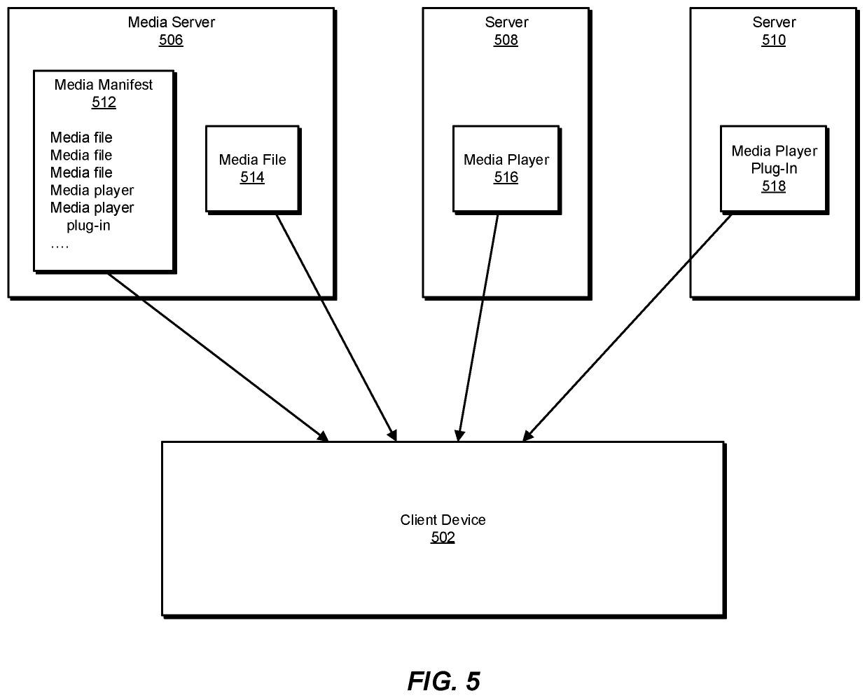

In some embodiments, the systems described herein may create a media manifest that includes non-media files that point to files stored on servers other than the server that hosts the media files. For example, a media manifest may include links to download media players, plug-ins, and/or other media-relevant files by various software publishers that are hosted on the publishers' servers. In one example, as illustrated in FIG. 5, a client device 502 may request and receive a media manifest 512 from a media server 506. In one example, media manifest 512 may list a media file 514 that is also hosted on media server 506, a link to download a media player 516 that is hosted on a server 508, and/or a link to download a media player plug-in 518 that is hosted on a server 510.

In some examples, the systems described herein may facilitate the playing of a media item via an application that is not traditionally used as a media player. For example, a media manifest may list model positioning data that can be used by a rendering engine to recreate the positions of models over periods of time and display those positions as a video. In one example, a client may request a media item that is a recording of a game from an esports tournament. A video file of the recording may have a large file size. However, model position data that describes where each model was in the game environment at each time point may be comparatively small. In some examples, a client device equipped with the game engine may be able to recreate the recording based on the model position data.

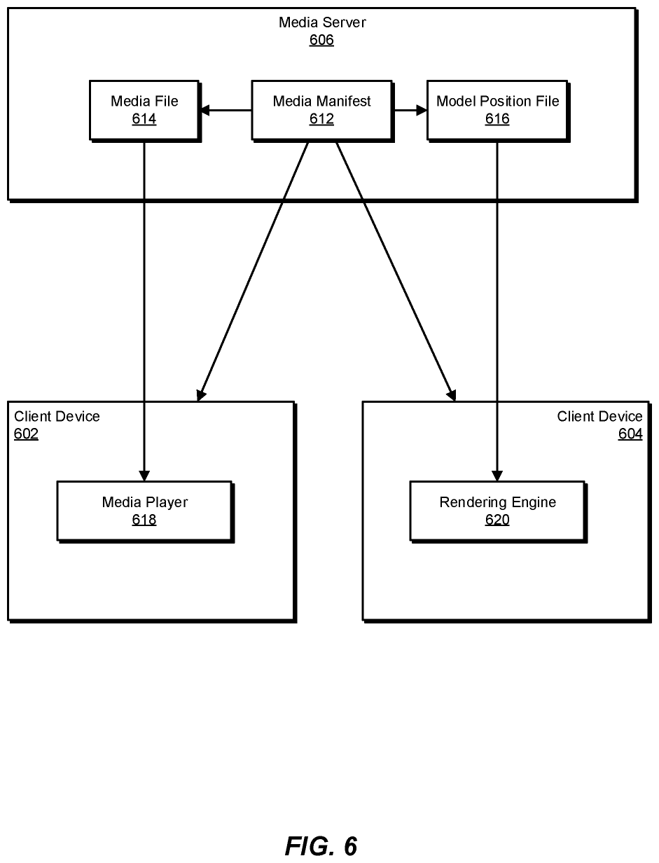

In some examples, the systems described herein may offer both traditional video files and model position data for the same media item. For example, as illustrated in FIG. 6, a media server 606 may host a media manifest 612 that lists both a media file 614 and a model position file 616 for the same media item. A client device 602 may request media manifest 612 and then, due to not being configured with an appropriate rendering engine, may request media file 614 rather than model position file 616. However, a client device 604 that is configured with a rendering engine 620 may request model position file 616 and use rendering engine 620 to reconstruct the media item.

In some embodiments, the systems described herein may create media manifests that facilitate the playing of a media item in a three-dimensional environment. For example, the systems described herein may create a manifest that includes multiple camera angles of cameras at a stadium, information on the camera sensors, optics, position, orientation, etc., in order to stream it to an off-site processing platform which can use this information to create a volumetric representation of the subjects within the stadium. In another example, the systems described herein may create a manifest that includes projection data for a version of the media item intended to be played in a three-dimensional environment. The projection data may enable a client device such as a virtual reality headset or 360 video player in a web browser to properly unwarp 360 video frames that are delivered to the client device.

In some embodiments, the systems described herein may create media manifests that include files that enhance the ability of a media player on a client device to play the media item. In one example, the systems described herein may create a manifest that includes machine learning model training data for a machine-learning-based media player on the client device. For example, the training data may be tailored to the media item to enable a machine learning model on the media player to more accurately facilitate play of the media item. Additionally or alternatively, the systems described herein may create a media manifest that includes a post-processing filter to be applied to the media file by the client device. For example, the media manifest may include a post-processing filter that is tailored to the media item and therefore will produce a higher-quality result when applied to the media item compared to a more generic post-processing filter that may already be installed on the client device (or compared to no post-processing).

As described above, the systems and methods described herein may improve the ability of client devices to play media items by creating media manifests that include non-media files, such as media players, media player enhancements, model positioning data, and other relevant files. Expanding manifest standards to enable the inclusion of non-media files in manifests may improve the field of streaming video as a whole by improving the versatility and quality of streaming video.

### Example Embodiments

Example 1: A method for creating media manifests that include non-media files may include (i) creating, for a media item, a media manifest that lists files that are relevant to the media item and available for download by a client device by (a) adding at least one media file to the media manifest that, when played by a media player on the client device, plays the media item and (b) adding at least one non-media file to the media manifest that cannot be played by the media player to play the media item but facilitates playing the media item and (ii) providing, by a server, to the client device, the media manifest that may include the at least one media file and the at least one non-media file. Various other methods, systems, and computer-readable media are also disclosed.

Example 2: The computer-implemented method of example 1, where the non-media file may include installation instructions for a media player that is not currently installed on the client device and that is capable of playing the media file.

Example 3: The computer-implemented method of examples 1-2, where the non-media file may include an updated version of the media player on the client device that enhances playback of the media file.

Example 4: The computer-implemented method of examples 1-3, where the non-media file may include a plug-in for the media player on the client device that enhances playback of the media file.

Example 5: The computer-implemented method of examples 1-4, where the non-media file may include a codec capable of decoding the media file.

Example 6: The computer-implemented method of examples 1-5, where the non-media file may include a post-processing filter to be applied to the media file by the client device.

Example 7: The computer-implemented method of examples 1-6, where the non-media file may include machine learning model training data that enhances playback of the media file on the client device.

Example 8: The computer-implemented method of examples 1-7, where the non-media file may include a decode complexity metric for the media file.

Example 9: The computer-implemented method of examples 1-8, where the non-media file may include projection data for a three-dimensional version of the media item.

Example 10: The computer-implemented method of examples 1-9, where the non-media file may include model position data for a rendering engine on the client device that is capable of rendering visuals based on the model position data.

Example 11: The computer-implemented method of examples 1-10, where creating the media manifest may include creating the media manifest in accordance with a manifest standard that specifies a format for media manifests that list media files and non-media files that meet predetermined requirements specified by the manifest standard.

Example 12: A system for creating media manifests that include non-media files may include at least one physical processor and physical memory including computer-executable instructions that, when executed by the physical processor, cause the physical processor to (i) create, for a media item, a media manifest that lists files that are relevant to the media item and available for download by a client device by (a) adding at least one media file to the media manifest that, when played by a media player on the client device, plays the media item and (b) adding at least one non-media file to the media manifest that cannot be played by the media player to play the media item but facilitates playing the media item and (ii) provide, by a server, to the client device, the media manifest that may include the at least one media file and the at least one non-media file. Various other methods, systems, and computer-readable media are also disclosed.

Example 13: The system of example 12, where the non-media file may include installation instructions for a media player that is not currently installed on the client device and that is capable of playing the media file.

Example 14: The system of examples 12-13, where the non-media file may include an updated version of the media player on the client device that enhances playback of the media file.

Example 15: The system of example 12-14, where the non-media file may include a plug-in for the media player on the client device that enhances playback of the media file.

Example 16: The system of examples 12-15, where the non-media file may include a codec capable of decoding the media file.

Example 17: The system of examples 12-16, where the non-media file may include a post-processing filter to be applied to the media file by the client device.

Example 18: The system of examples 12-17, where the non-media file may include machine learning model training data that enhances playback of the media file on the client device.

Example 19: The system of examples 12-18, where the non-media file may include a decode complexity metric for the media file.

Example 20: A non-transitory computer-readable medium may include one or more computer-readable instructions that, when executed by at least one processor of a computing device, cause the computing device to (i) create, for a media item, a media manifest that lists files that are relevant to the media item and available for download by a client device by (a) adding at least one media file to the media manifest that, when played by a media player on the client device, plays the media item and (b) adding at least one non-media file to the media manifest that cannot be played by the media player to play the media item but facilitates playing the media item and (ii) provide, by a server, to the client device, the media manifest that may include the at least one media file and the at least one non-media file. Various other methods, systems, and computer-readable media are also disclosed.

As detailed above, the computing devices and systems described and/or illustrated herein broadly represent any type or form of computing device or system capable of executing computer-readable instructions, such as those contained within the modules described herein. In their most basic configuration, these computing device(s) may each include at least one memory device and at least one physical processor.

In some examples, the term “memory device” generally refers to any type or form of volatile or non-volatile storage device or medium capable of storing data and/or computer-readable instructions. In one example, a memory device may store, load, and/or maintain one or more of the modules described herein. Examples of memory devices include, without limitation, Random Access Memory (RAM), Read Only Memory (ROM), flash memory, Hard Disk Drives (HDDs), Solid-State Drives (SSDs), optical disk drives, caches, variations or combinations of one or more of the same, or any other suitable storage memory.

In some examples, the term “physical processor” generally refers to any type or form of hardware-implemented processing unit capable of interpreting and/or executing computer-readable instructions. In one example, a physical processor may access and/or modify one or more modules stored in the above-described memory device. Examples of physical processors include, without limitation, microprocessors, microcontrollers, Central Processing Units (CPUs), Field-Programmable Gate Arrays (FPGAs) that implement softcore processors, Application-Specific Integrated Circuits (ASICs), portions of one or more of the same, variations or combinations of one or more of the same, or any other suitable physical processor.

Although illustrated as separate elements, the modules described and/or illustrated herein may represent portions of a single module or application. In addition, in certain embodiments one or more of these modules may represent one or more software applications or programs that, when executed by a computing device, may cause the computing device to perform one or more tasks. For example, one or more of the modules described and/or illustrated herein may represent modules stored and configured to run on one or more of the computing devices or systems described and/or illustrated herein. One or more of these modules may also represent all or portions of one or more special-purpose computers configured to perform one or more tasks.

In addition, one or more of the modules described herein may transform data, physical devices, and/or representations of physical devices from one form to another. For example, one or more of the modules recited herein may receive image data to be transformed, transform the image data into a data structure that stores user characteristic data, output a result of the transformation to select a customized interactive ice breaker widget relevant to the user, use the result of the transformation to present the widget to the user, and store the result of the transformation to create a record of the presented widget. Additionally or alternatively, one or more of the modules recited herein may transform a processor, volatile memory, non-volatile memory, and/or any other portion of a physical computing device from one form to another by executing on the computing device, storing data on the computing device, and/or otherwise interacting with the computing device.

In some embodiments, the term “computer-readable medium” generally refers to any form of device, carrier, or medium capable of storing or carrying computer-readable instructions. Examples of computer-readable media include, without limitation, transmission-type media, such as carrier waves, and non-transitory-type media, such as magnetic-storage media (e.g., hard disk drives, tape drives, and floppy disks), optical-storage media (e.g., Compact Disks (CDs), Digital Video Disks (DVDs), and BLU-RAY disks), electronic-storage media (e.g., solid-state drives and flash media), and other distribution systems.

The process parameters and sequence of the steps described and/or illustrated herein are given by way of example only and can be varied as desired. For example, while the steps illustrated and/or described herein may be shown or discussed in a particular order, these steps do not necessarily need to be performed in the order illustrated or discussed. The various exemplary methods described and/or illustrated herein may also omit one or more of the steps described or illustrated herein or include additional steps in addition to those disclosed.

The preceding description has been provided to enable others skilled in the art to best utilize various aspects of the exemplary embodiments disclosed herein. This exemplary description is not intended to be exhaustive or to be limited to any precise form disclosed. Many modifications and variations are possible without departing from the spirit and scope of the instant disclosure. The embodiments disclosed herein should be considered in all respects illustrative and not restrictive. Reference should be made to the appended claims and their equivalents in determining the scope of the instant disclosure.

Unless otherwise noted, the terms “connected to” and “coupled to” (and their derivatives), as used in the specification and claims, are to be construed as permitting both direct and indirect (i.e., via other elements or components) connection. In addition, the terms “a” or “an,” as used in the specification and claims, are to be construed as meaning “at least one of.” Finally, for ease of use, the terms “including” and “having” (and their derivatives), as used in the specification and claims, are interchangeable with and have the same meaning as the word “comprising.”

1. A computer-implemented method comprising:
creating, for a media item, a media manifest that lists files that are relevant to the media item and wherein entries in the manifest enable client devices to retrieve files represented by the entries by:
adding an entry for at least one media file to the media manifest that, when played by a media player on the client device, plays the media item;
including a decode complexity metric for each media file with an entry in the media manifest; and
adding an entry for at least one non-media file to the media manifest that cannot be played by the media player to play the media item but enables the client device to play the media item; and
providing, by a server, to the client device, the media manifest that comprises the at least one media file and the at least one non-media file.

2. The computer-implemented method of claim 1, wherein the non-media file comprises installation instructions for a media player that is not currently installed on the client device and that is capable of playing the media file.

3. The computer-implemented method of claim 1, wherein the non-media file comprises an updated version of the media player on the client device that enhances playback of the media file.

4. The computer-implemented method of claim 1, wherein the non-media file comprises a plug-in for the media player on the client device that enhances playback of the media file.

5. The computer-implemented method of claim 1, wherein the non-media file comprises a codec capable of decoding the media file.

6. The computer-implemented method of claim 1, wherein the non-media file comprises a post-processing filter to be applied to the media file by the client device.

7. The computer-implemented method of claim 1, wherein the non-media file comprises machine learning model training data that enhances playback of the media file on the client device.

8. (canceled)

9. The computer-implemented method of claim 1, wherein the non-media file comprises projection data for a three-dimensional version of the media item.

10. The computer-implemented method of claim 1, wherein the non-media file comprises model position data for a rendering engine on the client device that is capable of rendering visuals based on the model position data.

11. The computer-implemented method of claim 1, wherein creating the media manifest comprises creating the media manifest in accordance with a manifest standard that specifies a format for media manifests that list media files and non-media files that meet predetermined requirements specified by the manifest standard.

12. A system comprising:
at least one physical processor;
physical memory comprising computer-executable instructions that, when executed by the physical processor, cause the physical processor to:
create, for a media item, a media manifest that lists files that are relevant to the media item and wherein entries in the manifest enable client devices to retrieve files represented by the entries by:
adding an entry for at least one media file to the media manifest that, when played by a media player on the client device, plays the media item;
including a decode complexity metric for each media file with an entry in the media manifest; and
adding an entry for at least one non-media file to the media manifest that cannot be played by the media player to play the media item but enables the client device to play the media item; and
provide, by a server, to the client device, the media manifest that comprises the at least one media file and the at least one non-media file.

13. The system of claim 12, wherein the non-media file comprises installation instructions for a media player that is not currently installed on the client device and that is capable of playing the media file.

14. The system of claim 12, wherein the non-media file comprises an updated version of the media player on the client device that enhances playback of the media file.

15. The system of claim 12, wherein the non-media file comprises a plug-in for the media player on the client device that enhances playback of the media file.

16. The system of claim 12, wherein the non-media file comprises a codec capable of decoding the media file.

17. The system of claim 12, wherein the non-media file comprises a post-processing filter to be applied to the media file by the client device.

18. The system of claim 12, wherein the non-media file comprises machine learning model training data that enhances playback of the media file on the client device.

19. (canceled)

20. A non-transitory computer-readable medium comprising one or more computer-readable instructions that, when executed by at least one processor of a computing device, cause the computing device to:
create, for a media item, a media manifest that lists files that are relevant to the media item and wherein entries in the manifest enable client devices to retrieve files represented by the entries by:
adding an entry for at least one media file to the media manifest that, when played by a media player on the client device, plays the media item;
including a decode complexity metric for each media file with an entry in the media manifest; and
adding an entry for at least one non-media file to the media manifest that cannot be played by the media player to play the media item but enables the client device to play the media item; and
provide, by a server, to the client device, the media manifest that comprises the at least one media file and the at least one non-media file.

21. The computer-implemented method of claim 1, wherein the decode complexity metric enables the client device to select media files from the manifest according to an available processing power of the client device.

22. The system of claim 12, wherein the decode complexity metric enables the client device to select media files from the manifest according to an available processing power of the client device.
